(19) United States
(12) Patent Application Publication
(10) Pub. No.: US 2014/0272385 A1
(43) Pub. Date: Sep. 18, 2014

(54) Graphene-Polymer Composite Material and Devices Utilizing the Same

(71) Applicant: Graphene Technologies, Inc., Novato, CA (US)

(72) Inventors: Robert Wayne Dickinson, San Rafael, CA (US); Donald Brookshire, JR., Mill Valley, CA (US)

(73) Assignee: Graphene Technologies, Inc., Novato, CA (US)

(21) Appl. No.: 14/216,559

(22) Filed: Mar. 17, 2014

Related U.S. Application Data
(60) Provisional application No. 61/798,167, filed on Mar. 15, 2013.

(51) Int. Cl. F21V 29/00

(52) U.S. Cl. CPC F21V 29/22
USPC 428/323; 252/74; 252/75

(57) ABSTRACT

Graphene composite material and devices using the same. The graphene is dispersed in material such as polyurethane, latex, other elastomers, and other polymers to produce a composite material having high heat transfer properties which make it particularly suitable for use in removing heat from LEDs and other electronic devices. Several examples of heat transfer devices utilizing the material are disclosed.

### RELATED APPLICATIONS

Provisional Application No. 61/798,167, filed Mar. 15, 2013, the priority of which is claimed.

### BACKGROUND OF THE INVENTION

1. Field of Invention

This invention pertains generally to composite materials and, more particularly, to a graphene-polymer composite material with high heat transfer properties and to devices utilizing the same.

2. Related Art

Heat generated by light emitting diodes (LEDs) and other electronic devices must be dissipated to prevent damage to nearby components and to prevent premature failure of the devices themselves. Techniques heretofore provided for that purpose have included heatsinks and fans as well as forms of cooling such as thermal grease and liquid cooling.

The problem is particularly severe with high power LEDs in which a substantial part of the electrical energy supplied to them is consumed in producing heat rather than light.

There is also a related need for a low cost, highly conductive, light transmissive conductor that can be used in the display industry.

### SUMMARY OF THE INVENTION

The invention provides a new and improved graphene composite material having high heat transfer properties which make it particularly suitable for use in removing heat from LEDs and other electronic devices. The graphene is dispersed in another material such as polyurethane, latex, other elastomers, and other polymers, and the composite material is used in heatsinks and other heat transfer devices.

### BRIEF DESCRIPTION OF THE DRAWINGS

FIG. 1 is an isometric view of one embodiment of an LED lamp assembly having a heatsink fabricated of a graphene composite material in accordance with the invention.

FIG. 2 is an exploded isometric view of the lamp assembly of FIG. 1.

FIG. 3 is an exploded isometric view of the base section of the lamp assembly of FIG. 1.

FIG. 4 is an isometric vertical sectional view of the lamp assembly of FIG. 1.

FIG. 5 is an isometric view of the heatsink in the lamp assembly of FIG. 1.

FIG. 6 is an isometric vertical sectional view of the heatsink in the lamp assembly of FIG. 1.

FIG. 7 is an isometric view of another embodiment of an LED lamp assembly having a heatsink fabricated of a graphene composite material in accordance with the invention.

FIG. 8 is an isometric vertical sectional view of the lamp assembly of FIG. 7.

FIG. 9 is an isometric view showing the under side the heatsink in the lamp assembly of FIG. 1.

FIG. 10 is an isometric vertical sectional view of the heatsink in the lamp assembly of FIG. 7.

FIG. 11 is an isometric view of another embodiment of an LED lamp assembly having a heatsink fabricated of a graphene composite material in accordance with the invention.

FIG. 12 is an isometric vertical sectional view of the heatsink in the lamp assembly of FIG. 11.

FIG. 13 is an isometric view of an embodiment of a heatsink fabricated of a graphene composite material in accordance with the invention.

FIG. 14 is an isometric view of another embodiment of a heatsink fabricated of a graphene composite material in accordance with the invention.

FIG. 15 is a table of parameters utilized in a series of controlled runs for producing graphene for use in the invention.

FIG. 16 is a graphical representation of a Raman modal analysis of the Graphene material produced by the controlled runs.

FIG. 17 is a graphical representation of metal oxide impurities in the Graphene material produced by the controlled runs.

FIG. 18 is a graphical representation of the effects of bead milling in reducing particle size in polymer solutions containing the Graphene material produced by the controlled runs.

FIG. 19 is a graphical representation of surface resistivity in coatings prepared with the bead milled polymer solutions.

FIG. 20 is a graphical representation of the relationship between particle size and surface resistivity in the coatings prepared with the bead milled polymer solutions.

FIG. 21 is a graphical representation of the light transmission and surface resistivity of the coatings prepared with the bead milled polymer solutions.

### DETAILED DESCRIPTION

A particularly preferred process for producing graphene particles for use in the invention is described in detail in U.S. Pat. No. 8,420,042, the disclosure of which is incorporated herein by reference. In that process, magnesium and carbon dioxide are combusted together in a highly exothermic reaction to produce carbon and magnesium oxide (MgO) products which are then separated and purified to produce graphenes of very high purity and quality. These graphenes also have excellent thermal and electrical conductivities. The purified graphene particles are ground and screened to provide particles of a desired size ranging from about 120 mesh to about 400 mesh, or about 37 to 125 microns.

If desired, the graphene can be functionalized, although, depending upon the composite material in which the graphene is to be used, functionalization may not be needed. A preferred process for functionalizing graphene utilizes an electrostatic precipitator in which graphene particles or powder are deposited on one of two opposing electrically conductive surfaces that are charged with a high DC voltage (e.g., 20 KV) so that material of a certain character is attracted to the other surface in the presence of specific gasses. The process is carried out in a closed chamber that is flooded with gas at ambient pressure. With functionalizing gases, the material attracted to the second electrode takes on atoms of elements in the gas, thereby imparting functional characteristics to the graphene. In applications where functionalizing gases are not used, the chamber is flooded with a gas such as carbon dioxide (CO₂), nitrogen (N₂), nitrous oxide (N₂0), argon (Ar), or ammonia (NH₃) to prevent combustion of the graphene particles.

Graphene prepared in this manner has been found to mix very well with polyurethane, latex and other elastomers and polymers, and because of its excellent thermal properties, the graphene significantly improves the thermal properties of the elastomer or polymer. The graphene is added to the elastomer or polymer prior to curing and while the elastomer or polymer is still in liquid form. Mixing can be done manually, although better dispersion of the graphene can probably be obtained with an ultrasonic mixer or a rotary blade mixer.

The conductivity of the composite material is dependent upon the amount of graphene in it, and good results have been obtained, for example, with 320 mesh graphene (about 45 microns) prepared by the process described above dispersed in polyurethane at a concentration of about 5 to 20 percent, by weight. Such material is well suited for use in transferring heat away from LEDs and other electronic devices.

Heatsinks and other heat transfer devices can be advantageously fabricated of the composite material by 3D printing. 3D printers are now widely available and commonly use carbon black and polymers in laying down successive layers to make three dimensional solid objects of desired shapes. The composite material can be used either by replacing the polymer that is normally used with the composite material in uncured form or by using the graphene in place of the carbon black. 3D printing has the advantage of being an additive process which is more efficient and cost effective than conventional machining processes in which material is removed.

As discussed more fully hereinafter, it has been observed that mixing graphene with 3D printer urethane produces changes in electrical characteristics.

An LED lamp assembly with a heatsink fabricated of the composite material is illustrated in FIGS. 1-6. This lamp has a cylindrical plastic housing 21 surrounded by a heatsink 22 having a cylindrical inner wall 22a that fits snugly on the housing with axially elongated, radial fins 22b extending therefrom. The fins outer taper inwardly from top to bottom, with a concave curvature, giving the heatsink a generally frusto-conical outer shape. A screw base 23 extends from the lower end of the housing.

A ring of LEDs 26 are mounted on a circuit board 27 within a generally hemispherical glass bulb 28 on the upper side of the heatsink. The circuit board is mounted on a mounting surface 29 with a recessed area 31 for heat transfer compound 32 and a peripheral well 33 for excess heat transfer compound. The circuit board is secured tightly to the mounting surface by mounting screws 34 that pass through openings 36 in the top of the heatsink and are threadedly received in bosses 37 at the upper end of housing 21. In addition to ensuring good heat transfer between the circuit board and the heatsink, the mounting screws also serve to hold the assembly together.

Power conditioning circuitry for the LEDs is mounted on a circuit board 38 within the housing, with electrical leads 39 passing through openings 41 in the heatsink to circuit board 27. Epoxy insulation 42 is injected into the housing between circuit board 39 and the side wall of the housing.

The heatsink is fabricated of the composite material as a unitary structure by a suitable process such 3D printing, and with the unusually high heat transfer properties of the graphene, the composite material is very effective in removing and dissipating heat from the LEDs.

An LED lamp assembly having a heatsink 44 with a parabolic reflector made of the composite material is illustrated in FIGS. 7-10. This assembly has a separate power conditioning unit 46 which can be positioned away from the LEDs.

An LED circuit board 47 similar to circuit board 27 is mounted on the upper wall 48 of heatsink 44 beneath a glass bulb or dome 49. The top wall has a parabolic contour and serves as a parabolic reflector for light produced by the LEDs. A plurality of heat transfer fins 51 extend downwardly from the under side of top wall 48. These fins are arranged in a central circular group 51a surrounded by three annular groups 51b, 51c, and 51d of increasing diameter, as viewed from below, giving the heatsink an overall cylindrical shape. The power unit and circuit board are interconnected by a power cord or cable 52 that passes through openings 53 in the fins and the top wall of the heatsink.

Here again, the heatsink is fabricated as a unitary structure of the composite material by 3D printing or another suitable process.

The LED lamp assembly illustrated in FIGS. 11 and 12 has a short circular heatsink 56 with radially extend fins 57 fabricated of the composite material. An LED circuit board 58 is mounted on a mounting surface 59 at the center of the heatsink, with a depressed area 61 for heat transfer compound, an opening 62 in the recessed area for extra heat transfer compound, and openings 63, 64 for mounting screws (not shown) and the connecting cord 66 from an external power conditioning unit 67. As in the other embodiments, heatsink 56 is fabricated as a unitary structure of the composite material by 3D printing or another suitable process.

FIGS. 13 and 14 illustrate two additional embodiments of heatsinks which can be fabricated of the composite material. Heatsink 67, which is shown in FIG. 13, has a generally planar, rectangular mounting plate or base 68 with rows of generally rectangular fins 69 extending from one side of the base. Heatsink 71, which is shown in FIG. 14, has a generally rectangular base 72 with rounded ends, a mounting surface 73 for an LED circuit board (not shown), and a recessed area 74 in the mounting surface for heat transfer compound. An array of cooling knobs 76 extends from the front side of the base plate, and mounting tabs 77 extend from the edges.

As in the other embodiments, heatsinks 71 and 72 are fabricated as unitary structures of the composite material by 3D printing or another suitable process.

The composite material itself has been observed to have an electrical resistance that varies with factors such as current, temperature, and mechanical factors such as movement, elongation, twisting, and bending. This suggests that the material may also be useful in applications such as strain gauges, temperature sensors, variable resistors, and heaters.

With the graphene composite material, it may also be possible to build a thermal system having varying heat transfer properties that depend on the outside environment. Thus, for example, by applying a relative low voltage to the material, heat transfer can be altered in situ to keep an LED at a constant operating temperature. With a constant temperature, the LED illumination intensity and frequency will be constant.

The process for producing graphene particles by the combustion of magnesium and carbon dioxide, which is referred to above and described in greater detail in U.S. Pat. No. 8,420,042, is a solid gas reaction that is typically carried out in a batch mode in a graphite vessel. In these reactors, it has been found that material collected from different regions can vary in agglomeration or quality. Graphene samples have been collected from wall and core zones of the reactor for testing and characterization, and tests have been conducted on them to determine the nature of the material produced in the different zones as well as the impact of factors such as reaction time (“run time”), carbon dioxide (CO2) gas flow, and a carbon monoxide (CO) gas additive on the final graphene properties.

The table in FIG. 15 shows the parameters for a series of seven runs, designated Runs 1-7, with run times ranging from 5 to 16 minutes, CO2 flow rates ranging from 2.0 to 10.0 cubic feet per minute (CFM), and CO flow rates ranging from 0 to 0.595 CFM. Samples from each run were collected from both wall and core zones of the reactor. In addition, reference (“standard”) samples were also collected for each run without separation with regard to wall and core zones.

After post reaction and thermal treatment of the samples, Raman analysis was performed on the dry graphene powder, and the results are shown in FIG. 16 as the ratios of the Raman G′ and G modes and the Raman D and G modes. The G′ mode is indicative of the number of layers in the graphene, with the value of G′ increasing as the number of layers decreases. The D mode is indicative of defects in the graphene, and the value of D increases with the number of defects. As this figure shows, the core zone sample from a given run generally has a higher G′/G ratio and a lower D/G ratio than the wall zone sample from the same run, and the core samples from Runs 4 and 7 had the best overall quality of all of the samples.

Samples from each run were also analyzed for purity by an “ash test” in which carbon the samples were heated to a point where all carbon is removed and the remaining “ash” is metal oxide impurities. The results of this test are shown in FIG. 17, where the ash content is shown in units of percentage by weight. As seen in this figure, the core samples overall had lower impurities than the wall samples. The core samples from Runs 2 and 7 had the lowest ash content, and all of the core and wall samples had fewer impurities than the standard blend and standard black core materials.

FIG. 18 shows the results of reducing the size of samples from each of the runs by bead milling. For each run, 10 grams of graphene powder was dispersed in 90 grams of liquid epoxy resin such as Epon® Resin 828, with dispersant and solvent, as needed, to keep the solution flowing. Suitable solvents include NMP (N-Methyl-2-pyrrolidone) and butyl acetate. Each batch was bead milled for 2 hours with 0.8 mm ceramic beads, then milled for another 2 hours with 0.3 mm ceramic beads. The size of the particles in the milled solutions was measured by laser light scattering, and as the figure shows, the resulting particles ranged in size from about 0.7 micron to about 3.7 microns. Except for the Run 2 core zone sample, which reached its minimum particle size with the 0.8 mm beads, the smaller beads generally produced smaller particles than the larger beads.

Coatings of the bead milled solutions were applied to substrates, then dried and cured in an oven. In applying the coatings, a curative was added, and each of the solutions was coated onto the substrates using both #5 and #10 wire wound rods to provide coatings of different thicknesses for each of the specimens. In this particular embodiment illustrated, the substrates were a 5 mil polyethylene terephthalate (PET) film, and the coatings were cured at a temperature of 150° C. As known to those familiar with the art, PET is a thermoplastic polymer resin and a member of the polyester family of polymers.

The resistivity or conductivity of the coatings was analyzed, and FIG. 19 shows the relationship between the measured surface resistivity, the size of the milling beads, and the thickness of the coating. Overall, the smaller beads produce smaller particles and higher surface resistivity, and the thicker coatings have lower surface resistivity than the thinner ones. Significantly, the coatings containing the Run 3 core material had consistently lower surface resistivity values by more than an order of magnitude.

FIG. 20 shows the relationship between particle size (FIG. 18) and surface resistivity (FIG. 19). Here, again, surface resistivity is seen to decrease as particle size increases, with the coatings formed of the solutions containing the Run 3 core material having significantly lower surface resistivity than the coatings containing material from the other runs.

Coatings containing the Run 3 core material have also been analyzed for light transmission by ultraviolet and visible absorption spectroscopy (UV-Vis), along with coatings containing a standard sample collected without regard to wall and core zones. The solutions from which the coatings were prepared consisted of 5 percent graphene, by weight, dispersed in liquid epoxy resin. The transmission analysis was performed with light having a wavelength of 550 nanometers (nm), and FIG. 21 shows both the percentage of light transmitted by several samples of each coating and the surface resistivity each sample. As the figure shows, one of the samples with the core zone material had a light transmission of about 14 percent and a resistivity of about 40 K-ohms, whereas the resistivity of all of the coatings with the standard material was greater than 1,000 K-ohms.

The invention has a number of important features and advantages. It provides thermoplastic polymer composite materials having increased thermal conductivity, visual transmissibility, and increased electrical conductivity due to the graphene integrated therein. These materials are particularly suitable for use in removing excess heat from electro-mechanical devices, and examples of heat transfer devices utilizing the material are disclosed. They are also suitable for use in light transmissive polymer coatings that can be used in the display industry.

It is apparent from the foregoing that a new and improved graphene-polymer composite material and devices using that material have been provided. While only certain presently preferred embodiments have been described in detail, as will be apparent to those familiar with the art, certain changes and modifications can be made without departing from the scope of the invention as defined by the following claims.

1. A graphene-polymer composite material, comprising graphene having a particle size of about 37 to 125 microns dispersed in a thermoplastic polymer at a concentration of about 5 to 20 percent, by weight.

2. The composite material of claim 1 wherein the graphene is prepared by combusting magnesium and carbon dioxide together in a highly exothermic reaction to produce carbon and magnesium oxide, separating the carbon from the magnesium oxide, purifying the separated carbon, and grinding and screening the purified carbon to provide particles having a size in the range of about 37 to 125 microns.

3. The composite material of claim 1 wherein the polymer is in liquid form when the graphene particles are dispersed in it.

4. The composite material of claim 3 wherein the material is solidified and formed into a heatsink or other heat transfer device.

5. The composite material of claim 3 wherein the material is formed into a solid object by 3D printing.

6. The composite material of claim 1 wherein the polymer is selected from the group consisting of polyurethane, latex, other elastomers, and other polymers.

7. A graphene-polymer composite material, comprising graphene having a particle size of about 0.7 to 3.7 microns dispersed in a thermoplastic polymer.

8. The composite material of claim 7 wherein the is prepared by combusting magnesium and carbon dioxide together in a highly exothermic reaction to produce carbon and magnesium oxide, separating the carbon from the magnesium oxide, purifying the separated carbon, grinding and screening the purified carbon to provide graphene particles having a size in the range of about 37 to 125 microns, disbursing the graphene particles in a solution of liquid polymer resin, and bead milling the solution to reduce the size of the particles to about 0.7 to 3.7 microns.

9. The composite material of claim 8 wherein the bead milled solution is coated onto a substrate and cured.

10. The composite material of claim 9 wherein the substrate is a polymer film.

11. The composite material of claim 7 wherein the graphene particles are disbursed in a liquid epoxy resin.

12. A heatsink or other heat transfer device fabricated a graphene-polymer composite material having a high thermal conductivity.

13. The heatsink or other heat transfer device of claim 12 wherein the composite material includes graphene having a particle size of about 37 to 125 microns dispersed in a thermoplastic polymer at a concentration of about 5 to 20 percent, by weight.

14. The heatsink or other heat transfer device of claim 13 wherein the graphene is prepared by combusting magnesium and carbon dioxide together in a highly exothermic reaction to produce carbon and magnesium oxide, separating the carbon from the magnesium oxide, purifying the separated carbon, and grinding and screening the purified carbon to provide particles having a size in the range of about 37 to 125 microns.

15. The heatsink or other heat transfer device of claim 12 wherein the composite material includes a polymer selected from the group consisting of polyurethane, latex, other elastomers, and other polymers.

16. The heatsink or other heat transfer device of claim 12 wherein the graphene-polymer composite material is formed into a solid object by 3D printing.
